(19) United States
(12) Patent Application Publication
(10) Pub. No.: US 2017/0204783 A1
(43) Pub. Date: Jul. 20, 2017

(54) Residential and Commercial Gas Generator Unit

(71) Applicant: Chongqing Panda Machinery Co., Ltd., Chongqing (CN)

(72) Inventors: Xueqing Du, Chongqing (CN); Yingjie Liang, Shanghai (CN)

(21) Appl. No.: 15/001,251

(22) Filed: Jan. 20, 2016

(51) Int. Cl. F02B 63/04; H02K 7/18

(52) U.S. Cl. CPC F02B 63/042; H02K 7/1815

(57) ABSTRACT

A residential and commercial generator unit includes a casing and a complete generator fixedly arranged inside the casing; a gas inlet and a gas outlet are arranged on the casing, and the complete generator includes an intake system, a gas system, a power system, an exhaust system and a cooling system from the gas inlet to the gas outlet in turn; the complete generator also includes an electric control box to solve such problems as too big volume and clumsy appearance and large space demands of a residential and commercial generator unit due to the complex internal structure, unreasonable assembling and low utilization efficiency of space.

### TECHNICAL FIELD

The Invention belongs to the power generation and conversion technical field, in particular relates to a residential and commercial generator unit.

### BACKGROUND

The generator is a kind of mechanical equipment which is driven by the water turbine, steam turbine, diesel engine or other power machinery for converting energy in other forms into electric energy, wherein, the energy generated from the water flow, the airflow, fuel combustion or nuclear fission is converted into mechanical energy and is transferred to the generator, and then converted into electric energy by the generator. It is in a wide range of uses in the fields of industrial and agricultural production, national defense, science and technology and everyday life.

Generally speaking, a residential and commercial generator unit is composed of an engine (providing kinetic energy), a generator (generating electric current) and a control system. According to different power sources, the residential and commercial generator unit can be categorized into the residential and commercial diesel generator unit, residential and commercial gas generator unit, residential and commercial gasoline generator unit, residential and commercial wind power generator unit, residential and commercial solar power generator unit, residential and commercial hydraulic power generator unit, and residential and commercial coal-burning power generator unit. More and more large and middle residential and commercial generator units have widely entered the family and business fields with their popularization, in particular the residential and commercial gas generator unit.

But for the moment, the traditional residential and commercial gas generator unit has such problems as too big volume, clumsy appearance and large space demands due to the complex internal structure, unreasonable assembling and low utilization efficiency of space.

Therefore, a residential and commercial generator unit having a simplified internal structure and optimized utilization of space with a smaller volume and floor space is now in urgent need.

### SUMMARY OF THE INVENTION

The Invention puts forward a residential and commercial generator unit to solve such problems of the traditional residential and commercial generator unit as too big volume and clumsy appearance and large space demands due to the complex internal structure and low utilization efficiency of space in the prior art.

The Invention is realized by the following technical scheme: a residential and commercial generating unit comprising a casing and a complete generator fixedly arranged inside the casing, a gas inlet and a gas outlet are arranged on the casing; the complete generator comprises an intake system, a gas system, a power system, an exhaust system and a cooling system from the gas inlet to the gas outlet in turn; the inlet of the intake system connects to the gas inlet, the outlet of the intake system connects to the inlet of the gas system, the outlet of the gas system connects to the exhaust system; the gas system connects to the power system and drives the power system to generate electricity; the exhaust system is arranged on one side of the power system, and the exhaust port of the exhaust system connects to the gas outlet.

Preferably, the casing comprises a chassis, a pair of opposite front screen plate and back screen plate and a pair of opposite first side screen plate and second side screen plate, and the surfaces of the front screen plate and the back screen plate are both in a form of arc.

Preferably, the first stand column is arranged between the first side screen plate and the front screen plate, and the second stand column is arranged between the first side screen plate and the back screen plate; the third stand column is arranged between the second side screen plate and the front screen plate, and the fourth stand column is arranged between the second side screen plate and the back screen plate; all surfaces of the first stand column, the second stand column, the third stand column and the fourth stand column are in a form of arc.

Preferably, a beam is arranged on the first side screen plate or the second side screen plate, and a cover plate is arranged on the beam by means of hinging; the surface of the cover plate is in a form of arc.

Preferably, an electric control box is arranged in the complete generator, and the electrical signal of the electric control box connects to the intake system, the gas system, the power system, the exhaust system and the cooling system.

Preferably, grid baffles are arranged at both the gas inlet and the gas outlet.

Preferably, the cooling system comprises a radiator and a fan, the fan and the radiator are arranged on the side of the power system.

Preferably, the intake system comprises an intake valve and a calibrator connecting to the intake valve; and a solenoid valve is arranged at the outlet of the calibrator.

Preferably, a gas pipe is arranged between the calibrator and the solenoid valve, and a connector is arranged between the calibrator and the gas pipe.

Preferably, the exhaust system comprises an exhaust pipe, and a silencer is arranged inside the exhaust pipe.

Using the above technical scheme, the advantages of the Invention lie in that by reasonably arranging the cooling system on the side of the power system in the complete generator of the residential and commercial generator unit, the cooling system can perform cooling and heat dissipation treatment to the heat from the power system in real time, and timely dissipate the heat from the casing of the residential and commercial generator unit to effectively make the complete generator more concentrated; furthermore, the surfaces of the front screen plate, the back screen plate, the first side screen plate and the second screen plate are all in a form of arc matching with the arc-shaped casing of the residential and commercial generator unit, and they are fixedly connected with arc-shaped stand columns to provide a bigger space for the central portion of the casing without increasing the peripheral area of the casing, and thus enhance the space utilization and reduce the floor space of the residential and commercial generator unit to a great extent.

### BRIEF DESCRIPTION OF THE DRAWINGS

To describe the technical scheme in the Embodiments of the Invention or in the prior art more clearly, the following drawings for describing the Embodiments or the prior art are briefly introduced. Obviously, the following drawings are only some Embodiments of the Invention, and it is easy for a person skilled in the art to obtain other drawings based on these drawings without any inventive work.

FIG. 1 is the exploded view for the residential and commercial generator unit of the Invention;

FIG. 2 is the exploded view for the casing of the residential and commercial generator unit of the Invention;

FIG. 3 is the exploded view for the gas system of the residential and commercial generator unit of the Invention;

FIG. 4 is the exploded view for the electric control box of the residential and commercial generator unit of the Invention;

FIG. 5 is the exploded front view for the complete generator internal structure of the residential and commercial generator unit of the Invention;

FIG. 6 is the exploded back view for the complete generator internal structure of the residential and commercial generator unit of the Invention.

In the drawings, 101—front screen plate; 102—back screen plate; 103—second side screen plate; 104—first side screen plate; 105—cover plate; 106—first stand column; 107—second stand column; 108—third stand column; 109—fourth stand column; 110—gas inlet baffle; 111—chassis; 112—electric control box; 113—intake chamber; 114—stainless steel screen plate; 115—generator; 116—fan; 117—water tank; 118—exhaust pipe; 201—beam; 202—cable clamp; 203—kettle; 204—kettle pedestal; 205—hinged chain; 206—hinged beam; 207—grid baffle; 208—side mounting plate; 209—second grid baffle; 210—emergency switch protection module; 211—emergency switch; 301—intake valve; 302—first sealing joint; 303—calibrator mounting bracket; 304—calibrator; 305—snap connector; 306—second sealing joint; 307—adaptor; 308—first tower joint; 309—fastening screw; 310—intake pipe; 311—intake pipe mounting plate; 312—second tower joint; 313—solenoid valve; 314—third sealing joint; 401—electric control switch; 402—controller; 403—breaker; 404—breaker mounting plate; 405—fuse box; 406—fuse; 407—fuse box mounting plate; 408—100A line terminal; 409—line terminal back panel; 410—core chip; 411—electric control box side plate; 412—ECU electronic control unit; 413—ECU mounting plate; 414—electric control box casing; 501—electric control box mounting plate; 502—upper cooling pipe; 503—cylinder wire; 504—spark plug; 505—damping device; 506—intake pipe; 507—lower cooling pipe; 508—battery clamp; 509—wound lead-acid battery; 510—standby battery; 511—copper wire terminal; 512—gas system; 513—generator beam; 514—distribution box; 515—4*100A line terminal; 516—intake system; 517—“On” button; 519—stainless steel pipe; 520—oil filter heater; 521—oil filter; 522—oil drain device; 523—battery heater.

### DETAILED DESCRIPTION OF THE EMBODIMENTS

The technical scheme in the Embodiments of the Invention will be described clearly and completely by combining with the drawings. Obviously, the described Embodiments are not the whole Embodiments of the Invention, but only a part. Based on the Embodiments of the Invention, other Embodiments obtained by a person skilled in the art without any inventive work are all within the protection scope of the Invention.

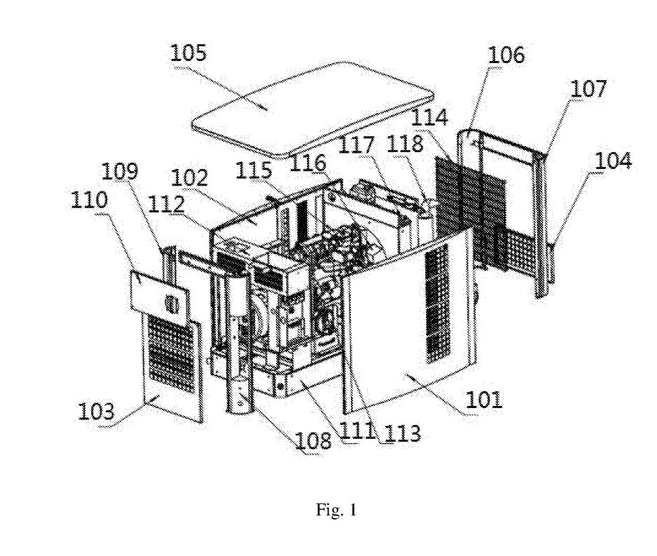

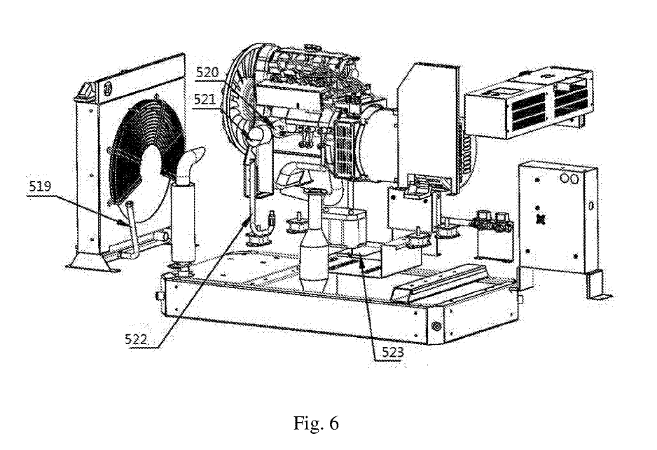

As shown in FIG. 1 and FIG. 6, the specific Embodiment of the Invention—a residential and commercial generator unit comprises a casing and a complete generator fixedly arranged inside the casing; a gas inlet and a gas outlet are arranged on the casing, and the complete generator comprises an intake system 516, a gas system 512, a power system, an exhaust system and a cooling system from the gas inlet to the gas outlet in turn; the gas inlet connects to the inlet of the intake system 516, the outlet of the intake system 516 connects to the inlet of the gas system 512, the gas system 512 connects to the power system and drives the power system to rotate; the exhaust system is arranged on one side of the power system, the exhaust port of the exhaust system connects to the gas outlet; the complete generator also comprises an electric control box 112, the electric control box 112 connects to the intake system 516, the gas system 512, the power system, the exhaust system and the cooling system via the electrical signal.

Furthermore, the exhaust system comprises an exhaust pipe 118, a silencer is arranged inside the exhaust pipe 118, and a mesh enclosure is arranged between the exhaust pipe 118 and the first side screen plate 104; the mesh enclosure can be of stainless steel, and the stainless steel mesh enclosure is fixed on the first stand column 106 and the second stand column 107 with screws for convenient dismantlement and subsequent maintenance.

To ensure better heat dissipation of the residential and commercial generator unit, meshes are arranged on the surfaces of the front screen plate 101, the back screen plate 102, the first side screen plate 104 and the second side screen plate 103 to effectively and timely dissipate the heat from the residential and commercial generator unit and thus avoid overheat. The cooling system comprises a fan 116 and a radiator, the fan 116 and the radiator are arranged on one side of the power system; when the power system works, it drives the fan 116 to rotate in the anti-clockwise direction, and wind pressure is formed by such rotation of the fan 116 to dissipate the heat from the radiator and the exhaust pipe 118; the negative pressure wind generated from the rotation of the fan 116 absorbs cold air from the gas inlet, and takes away the heat generated from the running residential and commercial generator unit through the air motion inside the casing to lower the inside temperature and further avoid overheat, so that the residential and commercial generator unit can function properly.

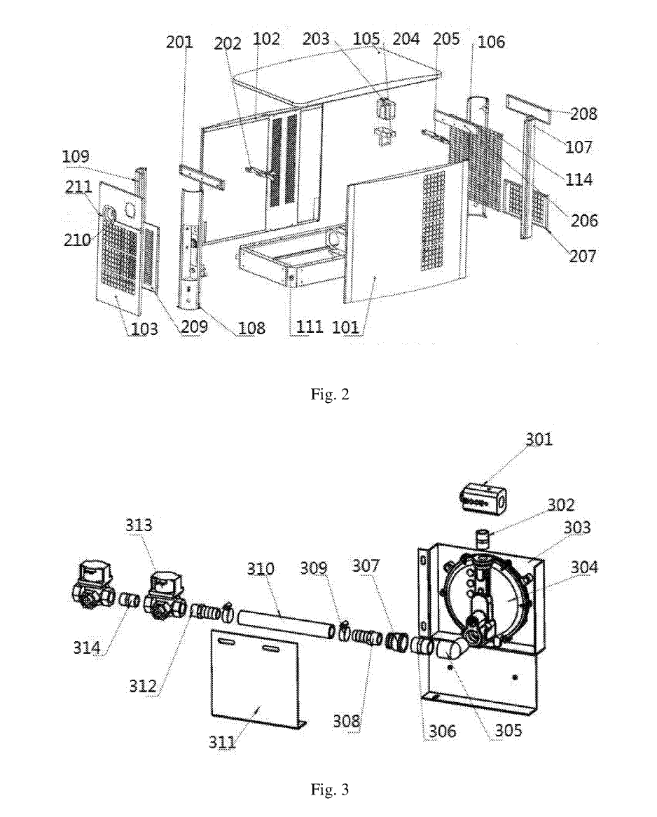

As shown in FIG. 2, the casing of the residential and commercial generator unit comprises a chassis 111, and a pair of opposite front screen plate 101 and back screen plate 102, a pair of opposite first side screen plate 104 and second side screen plate 103 fixed on the chassis 111; the first stand column 106 is arranged between the first side screen plate 104 and the front screen plate 101, the second stand column 107 is arranged between the first side screen plate 104 and the back screen plate 102, and the third stand column 108 is arranged between the second side screen plate 103 and the front screen plate 101, the fourth stand column 109 is arranged between the second side screen plate 103 and the back screen plate 102; a grid baffle 207 is arranged on the second side screen plate 103; wherein, the front screen plate 101 and the back screen plate 102 are fixed on the first stand column 106, the second stand column 107, the third stand column 108 and the fourth stand column 109 with manual nuts; a side mounting plate 208 is arranged between the first stand column 106 and the second stand column 107, a beam 201 is arranged on the second side screen plate 103, and the second grid baffle 209 is mounted inside the second side screen plate 103; a hinged beam 206 is arranged on the first side screen plate 104, and a hinged chain 205 is arranged on the hinged beam 206; a grid baffle 207 is arranged on the first side screen plate 104; a gas inlet baffle 110 is arranged on the second side screen plate 103, and a gas inlet is arranged on the gas inlet baffle 110; to further reduce the volume of the residential and commercial generator unit and increase its internal space utilization, the surfaces of the front screen plate 101, the back screen plate 102, the cover plate 105, the first stand column 106, the second stand column 107, the third stand column 108 and the fourth stand column 109 are all in a form of arc; an emergency switch 211 which is fixed with an emergency switch protection module 210 is arranged on the second side screen plate 103; the external surface of the casing is in a form of arc, which provides a bigger space for the internal central portion and makes it more beautiful with more layering.

As shown in the exploded view for the gas system of the Invention in FIG. 3, the gas system 512 comprises an intake valve 301; the intake valve 301 connects to a calibrator 304 mounted on the calibrator mounting plate 303; to ensure the leak tightness of the connection between the intake valve 301 and the calibrator 304, the first sealing joint 302 is arranged between the intake valve 301 and the calibrator; a 90° snap connector 305 which is bent at a 90° angle is arranged at the outlet of the calibrator 304 to further reduce its occupied space and increase the casing space utilization; an adaptor 307 is connected to the snap connector 305 via a second sealing joint 306; the outlet of the adaptor 307 connects to a first tower joint 308, and the outlet of the first tower joint 308 connects to an intake pipe 310 with fastening screws 309; the intake pipe 310 is mounted on the intake pipe mounting plate 311, and the outlet of the intake pipe 310 connects to the inlet of the second tower joint 312 with fastening screws 309; a solenoid valve 313 is arranged at the outlet of the second tower joint 312; the third sealing joint 314 is arranged at the outlet of the solenoid valve 313; to ensure that the intake system 516 is fixedly mounted, a calibrator 304 is mounted on the calibrator mounting bracket 303 which is fixed on the casing with screws; the intake pipe 310 is mounted on the intake pipe mounting plate 311 to keep it stable during the intake process, and avoid abrasion and air leakage due to the vibration of the intake pipe 310.

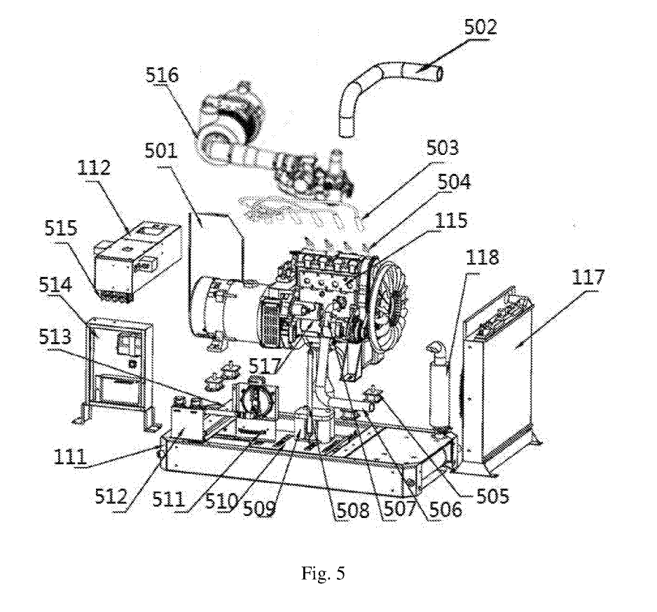

The internal structure of the complete generator of the Invention can be clearly seen in the exploded front view for the complete generator internal structure as shown in FIGS. 1-6, comprising a chassis 111, wherein, a distribution box 514, a gas system 512 and copper wire terminals 511 are arranged on the chassis 111; the generator 115 connecting to an intake pipe 506 is fixed on the chassis 111 via the generator beam 513; the battery and standby battery 510 are arranged in the generator 115, wherein, a wound lead-acid battery 509 is fixed on the chassis 111 via the battery clamp 508; the power system of the residential and commercial generator unit of the Invention employs the generator 115; an electric control box mounting plate 501 is arranged at one end of the generator 115 for installing the electric control box 112; the 4*100A line terminals 515 are arranged in the electric control box 112 to avoid the burnout of equipment components due to excess current; the “On” button 517 is arranged on the generator 115; a spark plug 504 connecting to a cylinder wire 503 is arranged on the top of the generator for starting up, and the cylinder is started up to work via the spark plug 504; a lower cooling pipe 507 is arranged at the bottom of the generator 115, and an upper cooling pipe 502 is arranged on the top of the generator 115; an exhaust pipe 118 is arranged at one end of the chassis 111, a silencer is arranged inside the exhaust pipe 118, and a water tank 117 is arranged as a radiator on one side of the exhaust pipe 118; a fan 116 is fixedly arranged on one side of the water tank 117 to lower its temperature; furthermore, a damping device 505 is arranged at the bottom of the generator 115 to keep it stable during the operation, which makes the generator 115 be mounted on the pedestal. As shown in the exploded back view for the complete generator internal structure in FIG. 5, the generator 115 has an oil filter 521 which is provided with an oil filter heater 520 on one side for heating of the oil filter 521 and is provided with an oil drain device 522; the oil drain device 522 has an oil drain pipe with an opening at the end for discharging the waste oil; a water pipe is arranged on the radiator - water tank 117, and the water pipe may be a stainless steel pipe 519 to avoid corrosion to the pipe material by the water.

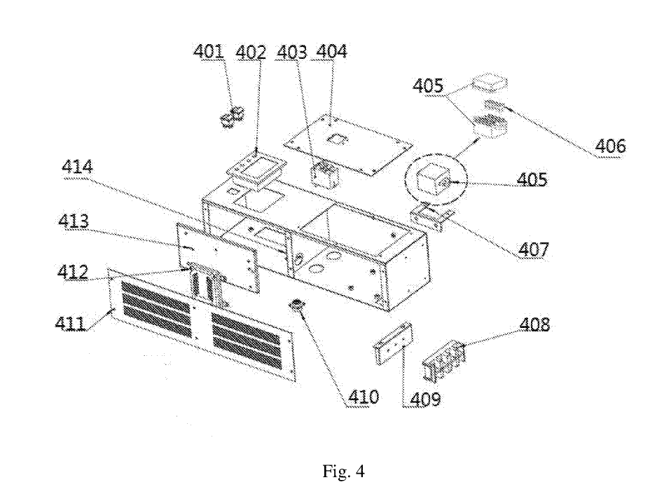

As shown in the exploded view for the electric control box of the residential and commercial generator unit in FIG. 4, the electric control box 112 comprises an electric control box casing 414; a controller 402 is arranged on the electric control box casing 414, and an electric control switch 401 is arranged on the controller 402; a breaker mounting plate 404 is arranged on the electric control box casing 414, and a breaker 403 is arranged on the breaker mounting plate 404; an electric control box side plate 411 is arranged on the side of the electric control box casing 414, and meshes are arranged on the electric control box side plate 411; a fuse box mounting plate 407 is arranged in the electric control box 112, and a fuse box 405 is fixed on the fuse box mounting plate 407; a fuse 406 is arranged in the fuse box 405, and the value of the fuse 406 can be set and adjusted according to the actual conditions to meet different requirements; a wireless communication module which can be a GSM communication module or a GPRS communication module is arranged in the electric control box 112; various function modules of the electric control box 112 are controlled via the core chip 410 which realizes its function control via the chip carrier socket; 4 line terminals 408 of 100A are arranged in the electric control box 112, and the line terminals 408 are mounted on the line terminal back panel 409; an ECU electronic control unit 412 is arranged in the electric control box 112 for convenient control; the ECU electronic control unit 412 can be mounted on the ECU mounting plate 413; the working condition of the residential and commercial generator unit can be controlled through the electric control box 112; the working condition of the residential and commercial generator unit can be sent to the user via the wireless communication module, which can also help to perform some simple controls.

The working principle of the residential and commercial generator unit is as follows: the gas enters the gas system 512 through the intake system 516, and mixes with the gas in the gas system 512; at this moment, the electric control box 112 makes the spark plug 504 ignite the gas in the gas system 512, and the gas combusts to act, the produced power drives the electric system, i.e., the generator 115 to rotate and produce electricity; as the generator 115 is bound to produce heat during the rotation, its temperature needs to be lowered; for this reason, a cooling system is arranged on one side of the generator 115 for heat dissipation through a radiator which is usually a water tank 117 with a fan 116 on one side; because the heat generated during the working process of the generator 115 gathers in the casing of the residential and commercial generator unit and results in excess temperature inside the casing, the rotation direction of the fan 116 may be anticlockwise to dissipate the heat from the radiator and the exhaust pipe 118; the negative pressure wind generated from the rotation of the fan 116 absorbs cold air from the gas inlet, and takes away the heat generated from the running residential and commercial generator unit through the air motion inside the casing to lower the inside temperature and further avoid overheat, so that the residential and commercial generator unit can function properly; the electric control box 112 is arranged in the residential and commercial generator unit to control all of its working processes, so the operation is simplified.

The casing of the residential and commercial generator unit is designed as a protruding arc, the front screen plate and the back screen plate are both processed into a form of arc, and stand columns also in a form of arc are arranged between the front screen plate, the back screen plate and the first side screen plate, the second side screen plate; the form of arc can make the available space of the residential and commercial generator unit more concentrated, and the same to the complete generator, and thus enhance the overall space utilization of the generator unit and reduce its volume and floor space.

The above are only preferred Embodiments, but are not used for limiting the Invention; any modifications, equivalent replacements and improvements made within the spirit and rule of the Invention shall be included in the protection scope of the Invention.

What is claimed is:

1. A residential and commercial generator unit comprising a casing and a complete generator fixedly arranged inside the casing, a gas inlet and a gas outlet arranged on the casing; wherein, the complete generator comprises an intake system, a gas system, a power system, an exhaust system and a cooling system from the gas inlet to the gas outlet in turn; the gas inlet connects to the inlet of the intake system, the outlet of the intake system connects to the inlet of the gas system, the gas system connects to the exhaust system, and connects to the power system and drives the power system to generate electricity; the exhaust system is arranged on one side of the power system, and the exhaust port of the exhaust system connects to the gas outlet.

2. The residential and commercial generator unit according to claim 1, wherein, the casing comprises a chassis, a pair of opposite front screen plate and back screen plate and a pair of opposite first side screen plate and second side screen plate, and the surfaces of the front screen plate and the back screen plate are both in a form of arc.

3. The residential and commercial generator unit according to claim 2, wherein, a first stand column is arranged between the first side screen plate and the front screen plate, and a second stand column is arranged between the first side screen plate and the back screen plate; a third stand column is arranged between the second side screen plate and the front screen plate, and a fourth stand column is arranged between the second side screen plate and the back screen plate; all surfaces of the first stand column, the second stand column, the third stand column and the fourth stand column are in a form of arc.

4. The residential and commercial generator unit according to claim 1, wherein, a beam is arranged on the first side screen plate or the second side screen plate, and a cover plate is arranged on the beam by means of hinging; the surface of the cover plate is in a form of arc.

5. The residential and commercial generator unit according to claim 2, wherein, a beam is arranged on the first side screen plate or the second side screen plate, and a cover plate is arranged on the beam by means of hinging; the surface of the cover plate is in a form of arc.

6. The residential and commercial generator unit according to claim 3, wherein, a beam is arranged on the first side screen plate or the second side screen plate, and a cover plate is arranged on the beam by means of hinging; the surface of the cover plate is in a form of arc.

7. The residential and commercial generator unit according to claim 1, wherein, an electric control box is arranged in the complete generator; the electrical signal of the electric control box connects to the intake system, the gas system, the power system, the exhaust system and the cooling system.

8. The residential and commercial generator unit according to claim 1, wherein, the cooling system comprises a radiator and a fan, the fan and the radiator are arranged on the side of the power system.

9. The residential and commercial generator unit according to claim 1, wherein, the gas system comprises an intake valve and a calibrator connecting to the intake valve; and a solenoid valve is arranged at the outlet of the calibrator.

10. The residential and commercial generator unit according to claim 7, wherein, a gas pipe is arranged between the calibrator and the solenoid valve, and a connector is arranged between the calibrator and the gas pipe.

11. The residential and commercial generator unit according to claim 1, wherein, the exhaust system comprises an exhaust pipe; a silencer is arranged inside the exhaust pipe.

12. The residential and commercial generator unit according to claim 1, wherein, a grid baffle is arranged at the gas inlet of the casing.
